(19) United States
(12) Patent Application Publication
(10) Pub. No.: US 2009/0187864 A1
(43) Pub. Date: Jul. 23, 2009

(54) Dynamically Scalable Hierarchy Navigation

(75) Inventors: Zachary Scott Bedell, Seattle, WA (US); Marti Kwok-Hung Wong, Hong Kong (HK)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/016,189

(22) Filed: Jan. 17, 2008

(51) Int. Cl. G06F 3/048

(52) U.S. Cl. 715/854

(57) ABSTRACT

A hierarchical navigation and display mechanism shows a focus node in a highlighted manner, with nodes on other levels of the hierarchy in a visually inferior manner. In many embodiments, levels that are successively removed from the focus node level may be displayed with successively visually inferior manners. Some embodiments may use color, transparency, size, or other mechanisms to illustrate visually inferior items. The navigation and display mechanism may include various controls and interactive areas for navigating through the hierarchy, expanding and collapsing groups of items within the hierarchy, and performing various operations with the items in the hierarchy. Some embodiments may include animated transitions when focus is transitioned from one node to another.

### BACKGROUND

Many data structures and systems may be arranged in a hierarchical fashion. For example, a file system may be defined with a root directory and several subdirectories. Each of the subdirectories may in turn contain several subdirectories. In another example, various elements of a computer network may be organized in a hierarchical fashion, such as server based applications where several servers and clients may be arranged in a hierarchical fashion to deliver a function or application. Some datasets, such as taxonomies may also be arranged in a hierarchical fashion.

### SUMMARY

A hierarchical navigation and display mechanism shows a focus node in a highlighted manner, with nodes on other levels of the hierarchy in a visually inferior manner. In many embodiments, levels that are successively removed from the focus node level may be displayed with successively visually inferior manners. Some embodiments may use color, transparency, size, or other mechanisms to illustrate visually inferior items. The navigation and display mechanism may include various controls and interactive areas for navigating through the hierarchy, expanding and collapsing groups of items within the hierarchy, and performing various operations with the items in the hierarchy. Some embodiments may include animated transitions when focus is transitioned from one node to another.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an example of a hierarchical data structure.

FIG. 2 is a diagram illustration of an embodiment showing a transition from a first to a second display of a hierarchical data structure.

FIG. 3 is a diagram illustration of an embodiment showing a hierarchical data structure with groups of items within a node.

FIG. 4 is a diagram illustration of an embodiment showing a device with a navigation tool for hierarchical datasets.

FIG. 5 is a flowchart illustration of an embodiment showing a method for displaying and navigating hierarchical datasets.

### DETAILED DESCRIPTION

A navigation tool for hierarchical data structures may show a focus node in a highlighted manner and successive levels of more distantly related items in a visually inferior manner. As nodes are further and further away from the focus node, the nodes may be displayed in smaller format, with less distinguished colors, with greater transparency, or otherwise be less eye catching. As a user traverses the hierarchy and selects other nodes as focus nodes, the display may be transformed so that the newly selected focus node is highlighted and nodes further away from the focus node are in a more visually inferior manner.

The navigation tool may show a focus node with more area or space on a display than other nodes, enabling a user to focus on that node. Other nodes may be shown in context to the focus node, with less space devoted to those nodes.

The navigation tool may be used to display and browse through a hierarchical data structure, and may be used within an application to perform various functions on the contents of a node. In some instances, the navigation tool may be used to browse a hierarchical set of data, such as the taxonomy of a scientific classification of organisms. An application may incorporate the navigation tool to allow a user to browse a hierarchical structure and perform various actions on the items within the structure.

For example, a navigation tool may be incorporated into a file browser. The navigation tool may enable a user to traverse the file structure, view the contents of various directories, and perform actions on files contained in the directories. The actions may include launching a related application, renaming a file, querying various properties, moving files from one location to another location, or other actions.

In another example, the navigation tool may be incorporated into a network monitoring application. The navigation tool may enable an administrator to browse a hierarchy of servers, clients, and other network devices that may be arranged in a hierarchical fashion. The network monitoring application may enable an administrator to browse certain characteristics or features of a client device, for example. The application may further enable the administrator to perform various administrative functions on the devices, launch various applications or scripts using parameters gathered in the browsing action, or other actions.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

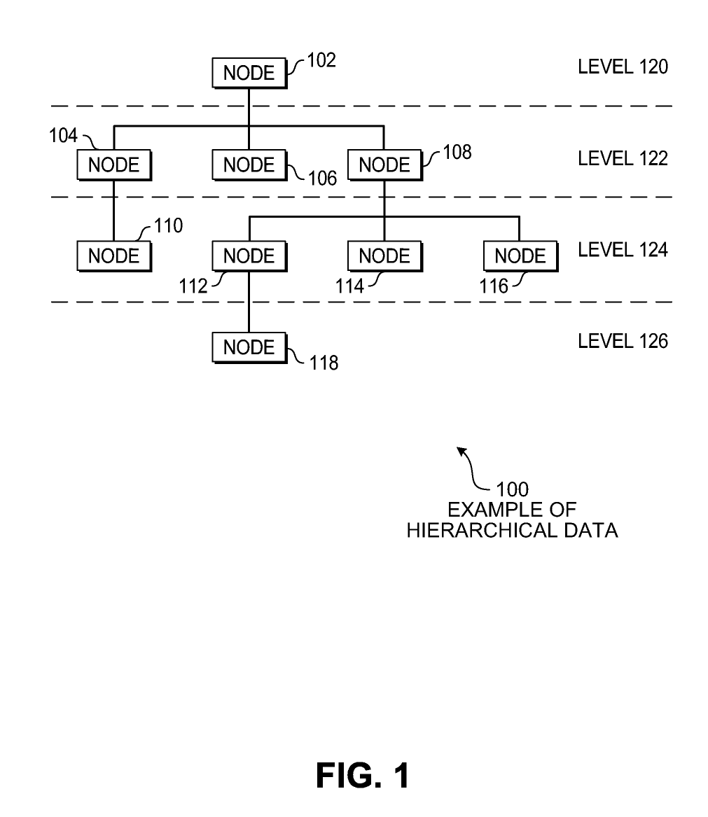

FIG. 1 is a diagram of an example embodiment 100 showing a hierarchical data structure. The hierarchical data structure of embodiment 100 may be used in several examples within this specification to illustrate a dynamically scalable hierarchical display and browsing mechanism.

The structure of embodiment 100 is merely a simplified example of a hierarchical data structure and is selected to illustrate various features. Each embodiment may have a different data structure and may contain more or fewer elements arranged in many different manners.

The node 102 may be a root node for the embodiment 100. In a hierarchical data structure, each node may have one or more child nodes, such as nodes 104, 106, and 108. The node 102 may be a parent node to nodes 104, 106, and 108. Nodes 104, 106, and 108 may be peer nodes with respect to each other.

In embodiment 100, node 110 may be a child node to node 104, and nodes 112, 114, and 116 may also be child nodes to node 108. Node 118 may be a child node to node 112.

In some hierarchical data structures, leaf nodes are those nodes that have no children and such nodes may have special characteristics or functions within the hierarchical data sets. In other embodiments, the leaf nodes may have the same functionality and characteristics of other nodes. In embodiment 100, nodes 106, 110, 114, 116, and 118 may each be considered leaf nodes.

Hierarchical data structures may be viewed as different levels of nodes. For example, the root node, node 102, may be on the highest level 120, while the children nodes 104, 106, and 108 may be on level 122. Similarly, level 124 may contain nodes 110, 112, 114, and 116. Level 126 contains node 118.

Sometimes, a hierarchical data structure may be described using generational terminology, where each level 120, 122, 124, and 126 may be described as generations. On level 122, each of the nodes 104, 106, and 108 may be peer nodes and may have a sibling relationship, as each node is related by a common parent as well as being in the same generational level 122.

On level 124, nodes 112, 114, and 116 may be siblings, but may have a ‘first cousin’ relationship to node 110. Nodes 112, 114, and 116 may be related with a common parent node 108, but share only a common grandparent node 102 with node 110.

The relationships between nodes may be used by a navigation tool to characterize and display the relative distance of a focus node to other nodes within the hierarchy. A focus node may be one or more nodes within the dataset that are highlighted within the navigation tool. Other nodes may be displayed with increasingly visually inferior representation mechanisms based on the relative distance from the focus node. As the focus node changes, the distance from the focus node to the other nodes may change and the visual representation of the nodes may also change.

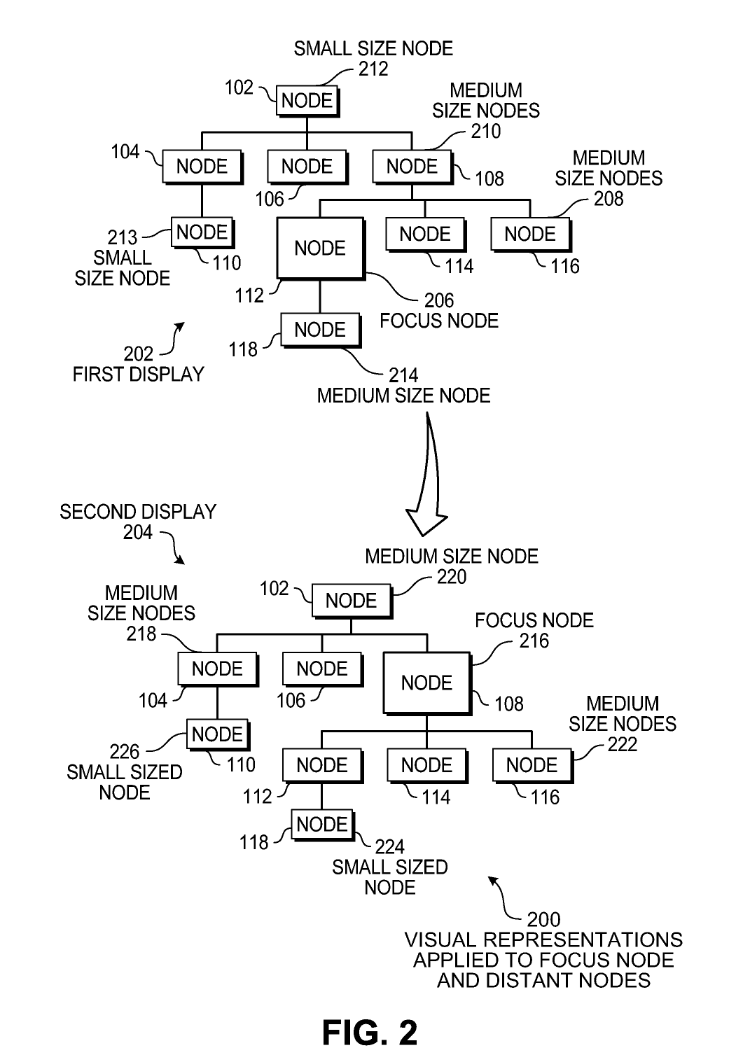

FIG. 2 is a diagram illustration of an embodiment 200 showing visual representations applied to a focus node and distant nodes. The embodiment 200 illustrates one mechanism to display the hierarchical data structure of embodiment 100 in a visual manner.

Embodiment 200 illustrates a first display 202 and a second display 204 that show two views of the hierarchical data structure of embodiment 100. In the first display 202, node 112 is selected as a focus node 206, and in the second display 204, node 108 is selected as the focus node 216.

Embodiment 200 may illustrate how a navigation tool may change from one view to another as a user traverses an underlying hierarchical data set. In some embodiments, an animated transition may be included between different views of the dataset.

In each view, a focus node is selected and presented with a highlighted visual representation. Nodes that are closely related may be presented with a less highlighted or visually inferior representation. Nodes that are more distantly related may be presented with an even more visually inferior representation.

The navigation tool may present focus nodes in a manner that enables a user to perform operations or functions with the focus node. For example, an application may use a navigation tool to navigate and browse various data structures and then perform various operations on elements contains within a focus node. Many different applications may use such a navigation and display mechanism.

When a focus node is displayed, other nodes may be displayed in a visually inferior manner. A visually inferior representation may include presenting a node with a smaller size, with a different color scheme, or in a transparent or semi-opaque manner. The presence of the other nodes may be used to navigate to those nodes and to give a context or reference for the focus node. As nodes are further removed from the focus node, the size of the nodes or other visual cues may be used to convey the distance from the focus node. In such an embodiment, a focus node may take up a large portion of the display space, with each related node being allocated much smaller area.

In the first display 202, node 112 is illustrated as the focus node 206. Various nodes that are closely related, such sibling nodes 114 and 116, child node 118, and parent node 108 may be displayed as medium sized nodes 208, 210, and 214. Distant nodes, such as nodes 102 and 110 that are two or more degrees away from the focus node 206 may be displayed as small size nodes 212 and 213.

In the second display 204, node 108 is illustrated as the focus node 216. In this case, node 112 that was the focus node in the first display 202 may be displayed as a medium sized node 222 along with nodes 114 and 116 as children of the focus node 216.

Node 118 that was displayed as a medium sized node in the first display 202 may be displayed as a small sized node 224 in the second display 204. Node 118 is a grandchild node of the focus node 216 in the second display 204, compared to being a child node to the focus node 206 in the first display 202.

Similarly, node 102 which was a grandparent node in the first display 202 was illustrated as a small sized node 212 may be illustrated as a medium sized node 220 as a parent node to the focus node 216 in the second display 204.

Nodes 104 and 106, as sibling nodes to focus node 216, may be displayed as medium sized nodes 218. Node 110 may be displayed as a small sized node 226 as the node 110 is a nephew node to the focus node 216.

The distance between the focus node and other nodes in the hierarchy may be used to determine how a node may be displayed with respect to a focus node. In some embodiments, the distance may be determined by the relative level of a node to the focus node. In other embodiments, the distance may be determined by determining the number of relationships between a node and a focus node.

By determining the relative level from a node to the focus node, the distance between the nodes may be approximated. For example, those nodes at a level above a focus node may be illustrated on a display by applying one visual representation to each of the nodes. The nodes one level removed may have a slightly visually inferior representation. Those nodes two levels above the focus node may have a visual representation applied that renders those nodes more visually inferior to the nodes one level removed from the focus node.

In some cases, a distance calculation may be determined by calculating the number of relationships between a node and a focus node. In such a case, nodes that are sibling nodes may be represented differently than those nodes that are cousin nodes. In the second display 204, node 110 is a nephew node to the focus node 216, which can be calculated as a two relationship distance from the focus node. The node 110 is illustrated as a small sized node 226. Nodes 112, 114, and 116 may be illustrated as medium sized nodes 222 as those nodes are a single relationship distance from the focus node 216. Nodes 110, 112, 114, and 116 are on the same relative level from the focus node 216, but have a different relationship with the focus node 216.

The various nodes and elements shown on the first display 202 may include navigation devices incorporated into the display. In many embodiments, the contents of the focus node 206 may include buttons or other user input mechanisms that may be activated with a mouse, stylus, touchscreen, pointing device, keyboard, or other input device. Similarly, a pointing device may be used to engage active areas on other nodes to change the display so that the selected node becomes the focus node. For example, a user may click on the node 108 in the first display 202 to transition to the second display 204 where node 108 is the focus node.

Each embodiment may have different input mechanisms and different capabilities built into the navigation mechanism.

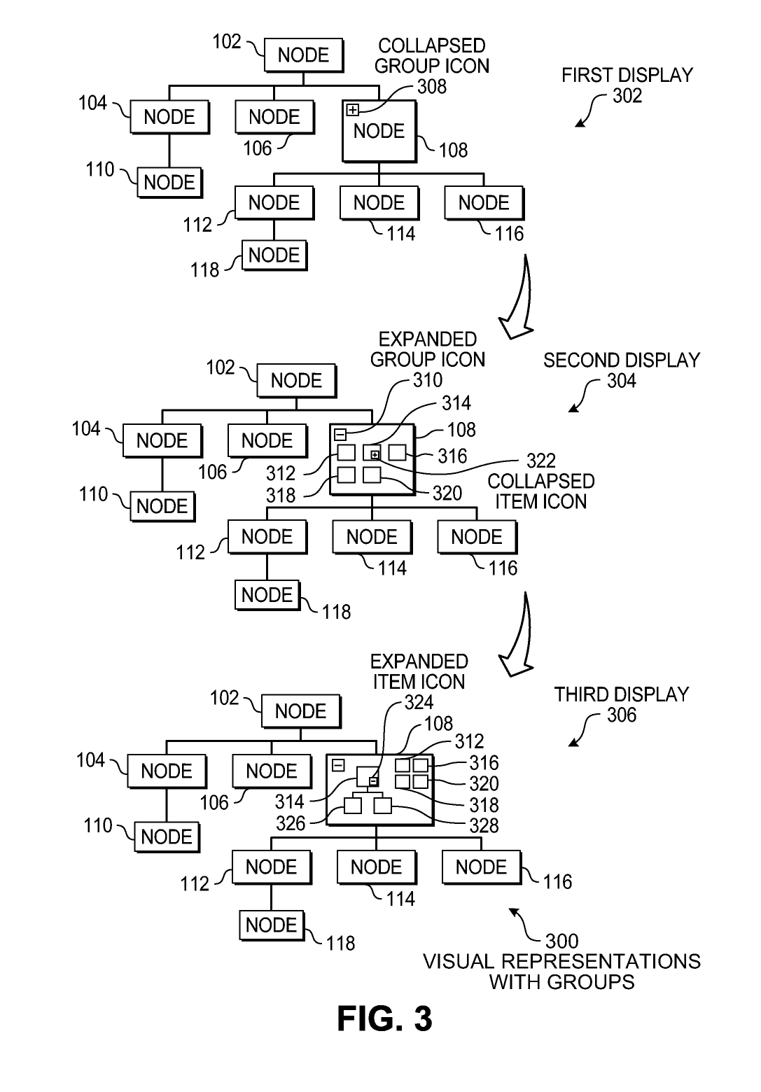

FIG. 3 is a diagram illustration of an embodiment 300 showing an example of visual representations using groups of items. Embodiment 300 may use the same example data structure as embodiment 100 to illustrate various functions and operations.

Embodiment 300 illustrates the succession of a first display 302 showing a focus node with an group indicator, a second display 304 with the group expanded, and a third display 306 with an item within the group as expanded. Embodiment 300 illustrates various displays using the nodes 102, 104, 106, 108, 110, 112, 114, 116, and 118 as described in embodiments 100 and 200.

In many embodiments, a hierarchical data structure may be used to organize data into an overall structure. Within the nodes of the data structure, individual items may be categorized or grouped. In some cases, operations may be performed on individual items or groups of items.

In the first display 302, node 108 is selected as a focus node and has a collapsed group icon 308. The collapsed group icon 308 may indicate that a group of items are included in the node, but are not shown in the display. When the collapsed group icon 308 is selected or engaged by a user input, the second display 304 may be generated that illustrates node 108 as a focus node with an expanded group icon 310 and several items 312, 314, 316, 318, and 320.

The collapsed group icon 308 and expanded group icon 310 may be used to indicate to the user that a collapsible group is present in the focus node and whether the group is collapsed or expanded. When expanded, the item members of the group may be shown. In some embodiments, individual items may be selected, manipulated, and may have various functions performed with the items.

In the second display 304, the item 314 may have a collapsed item icon 322. The collapsed item icon 322 may indicate that the item 314 may have sub-items related to the item 314. When the item 314 is expanded, the third display 306 may be shown.

The third display 306 may illustrate the hierarchical nodes with the focus node 108. Within the focus node 108, the item 314 is shown in an expanded mode with related items 326 and 328. Other items 312, 316, 318, and 320 are also shown.

The third display 306 may illustrate an embodiment where the focus node 108 has been expanded to show items within the node. In such a case, the remaining nodes may be given further visually inferior representations as items within the focus node 108 are expanded.

Each embodiment may provide different manners for representing visually inferior nodes or objects with respect to a focus item. In some cases, an embodiment may have a simplified mechanism where two or three distinct levels of visually inferior representations are used.

Embodiment 200 is an example where three different levels of representation are used: a focus node representation, a medium sized representation, and a small sized representation. Each degree of representation may have a visually inferior relationship with another representation, which may give the user a general perception of distance or importance of a node with respect to the focus node.

Other embodiments may use a finer degree of visual inferiority between a focus node and other nodes. For example, an embodiment that may display nodes with five, ten, or many more different levels or number of relationships from a focus node may use as many different degrees of visual inferiority between a focus node and other nodes. Some embodiments may scale the size of a node icon, apply different shades of color, or present a distant node with a high degree of transparency. In each case, an unlimited number of degrees of distance may be visually represented.

In the examples of embodiments 200 and 300, distant nodes may be presented with the same visual representations for nodes above and below the focus node. In other embodiments, different visual representations may be applied to nodes below a focus node than nodes above. For example, some embodiments may present lower level nodes with smaller sized representations than nodes above the focus node. Other embodiments may present nodes below the focus node with shades of red while nodes above the focus node may be presented with shades of blue.

As the navigation tool may be adapted to different uses and applied to different data sources, the visual representations may be changed and adapted to the characteristics of the data set or for the uses associated with the data set. For example, a navigation tool used to browse and explore a taxonomy of the animal kingdom may present lower level nodes with a larger and more detailed representation than upper level nodes. In a network administration use of the navigation tool, higher level nodes may be larger than lower level nodes so that a user may be able to determine a high level context for the focus node.

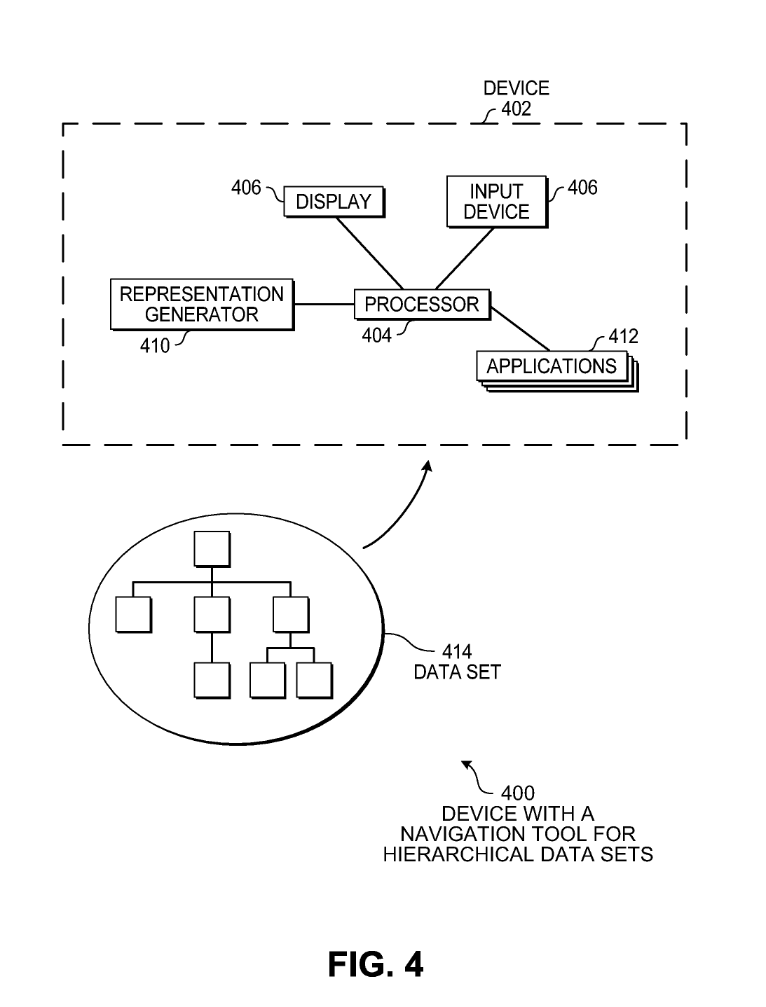

FIG. 4 is a diagram of an embodiment 400 showing a device with a navigation tool for hierarchical data sets. Embodiment 400 is a simplified example of a device that may receive a hierarchical data set and use a navigation tool in conjunction with one or more applications.

The diagram of FIG. 4 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 400 may be any type of device with a user interface. In a typical example, the device 402 may be a server or client computer, but in other examples, the device 402 may be a handheld wireless device, a mobile telephone, a network appliance, a television with a user input device, or any other type of device through which information may be displayed and a user input taken.

The device 402 may be configured with a processor 404 that may connect with a display 406 and input device 408. The processor 404 may be a general purpose processor that may execute various pre-programmed instructions. In some embodiments, the processor 404 may be a state machine or hardwired circuitry that performs some or all of the functions of a navigator for a hierarchical dataset.

The display 406 may be any type of graphical display. In some cases, the display 406 may be a separate component or peripheral to the device 402, while in other cases the display 406 may be integrated into the device 402.

The input device 408 may be one or more devices capable of receiving user input. Many devices may have at least one of a keyboard, mouse, pointer, touchscreen, or other device, and many devices may have two or more such input devices.

The representation generator 410 may work with various applications 412 to receive a hierarchical dataset 414 and generate a representation of the dataset 414 on the display 406. The input device 408 may be used to direct the applications 412 to create a different view of the data during navigation, as well as perform various functions on nodes or items within the nodes of the hierarchical dataset 414.

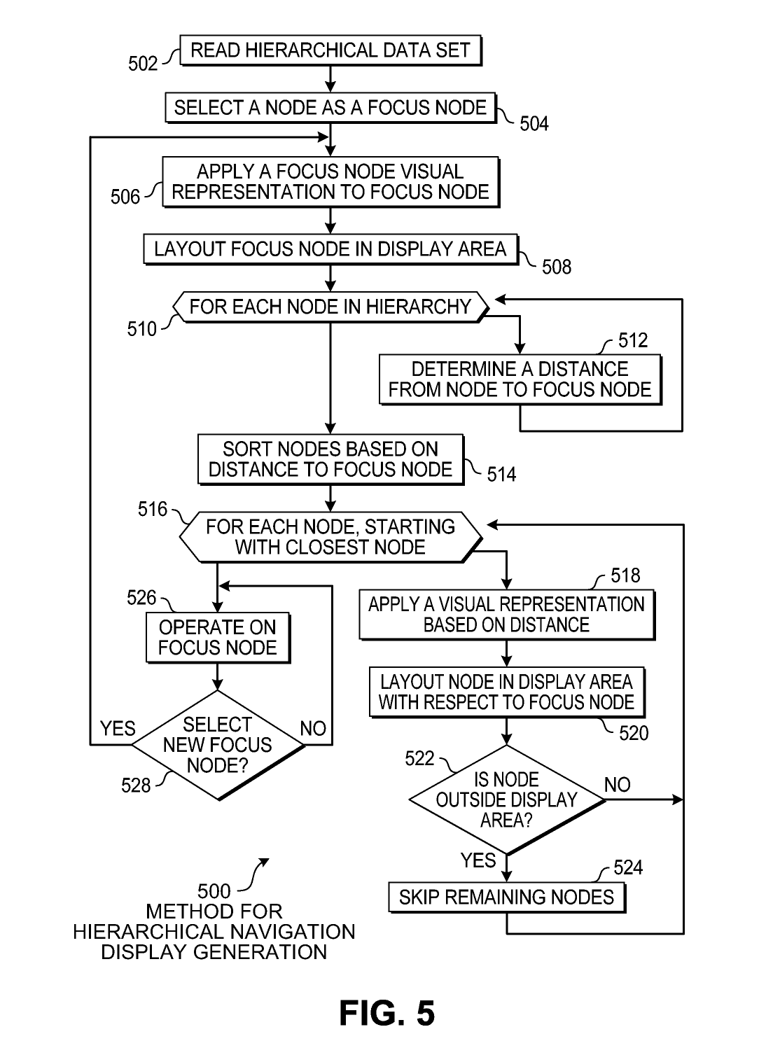

An example of a method used by a representation generator 410 may be found in embodiment 500 described in FIG. 5.

FIG. 5 is a flowchart illustration of an embodiment 500 showing a method for generating a representation of a hierarchical dataset and for navigating through the representation.

Embodiment 500 is merely one example of such a method. Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A hierarchical dataset may be read in block 502. The hierarchical data may represent any type of data or relationships between data, devices, or other elements.

In block 504, a node is selected as a focus node. A focus node is one which may be highlighted within a display and may certain functions or actions may be performed on the focus node. As a user navigates through a hierarchy of nodes, the user may select different nodes as a focus node and the display may change to show the focus node with other nodes and relationships to the other nodes with varying degrees of visual representations.

A visual representation may be applied to the focus node in block 506 and the focus node may be laid out in the display area in block 508. In many embodiments, a focus node may be laid out at or near the center of a display and representations of other nodes may be made with reference to the position of the focus node and with visual representations that are progressively inferior to the visual representation of the focus node.

For each node in the hierarchy in block 510, a distance from the node to the focus node is determined in block 512. In some embodiments, the distance determination may be made by determining a level for the focus node and comparing the level of a node to the level of the focus node. In other embodiments, the distance may be determined by counting the number of relationships between a node and the focus node. Other embodiments may also use other mechanisms to calculate or determine a distance factor for each node.

The nodes may be sorted by distance in block 514, and for each node starting with the closest node in block 516, a visual representation may be applied based on the distance in block 518. The node may be laid out in the display area in block 520 with respect to the focus node previously laid out and with respect to other nodes already laid out. If the current node is outside the display area in block 522, the remaining nodes may be skipped in block 524, otherwise the process may continue in block 516 with the next furthest node.

The process from block 516 to block 524 may build the remaining portions of a display by representing and placing the non-focus nodes. Each node may be given a visually inferior representation to those nodes with a shorter distance to the focus node.

Visually inferior may mean any mechanism or technique using size, shape, color, transparency, positioning, or other variable that may give the user a visual cue that one node is further away or less significant than another node. The navigation tool may select any node to be a focus node and may represent the remaining nodes to be at least somewhat visually inferior to the focus node in increasing degrees.

In many embodiments, each node may be displayed with a hot zone, button, or other user input mechanism so that any displayed node may be selected as a focus node. In some cases, such input mechanisms may enable a user to perform some operations on a non-focus node as well. For example, a left-click operation using a mouse may cause a node to become a focus node, while a right-click operation on a non-focus node may bring up a menu of one or more operations that may be performed on the node.

After the display is laid out with the focus node and other nodes, a user may operate on the focus node in block 526. The operations may be any type of function, operation, process, script, or other action that may be performed on a focus node or the contents of a focus node. Each application may have different types of data and perform different types of operations on the data.

If a new focus node is selected in block 528, the process may continue with block 506 using the newly selected node as the focus node.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
selecting a first node as a focus node, said focus node having a first level within a hierarchical group of nodes;
applying a first visual representation to said focus node;
identifying at least one second level node being associated with a second level, said second level being adjacent to said first level within said hierarchical group of nodes;
applying a second visual representation to said at least one second level node, said second visual representation being a visually inferior representation to said first visual representation; and
selecting one of said at least one second level nodes as said focus node and:
applying said first visual representation to said focus node; and
applying a third visual representation to said first node, said third visual representation being visually inferior to said first visual representation.

2. The method of claim 1, said third visual representation being the same as said second visual representation.

3. The method of claim 1, said second level being a parent level to said first level.

4. The method of claim 1, said second level being a child level to said first level.

5. The method of claim 1 further comprising, prior to said selecting:
identifying at least one third level node being associated with a third level, said third level being adjacent to said second level and being two levels removed from said first level within said hierarchical group of nodes; and
applying a fourth visual representation to said at least one third level node, said third level node being a visually inferior representation to said second visual representation;
said selecting further comprising:
applying said second visual representation to said at least one third level node.

6. The method of claim 1, said visually inferior comprising:
a smaller scale than a visually superior representation.

7. The method of claim 1, said visually inferior comprising:
a different color than a visually superior representation.

8. The method of claim 1, said visually inferior comprising:
a more transparent visual representation than a visually superior representation.

9. The method of claim 1, said focus node comprising a group of items, said focus node being represented with a group expansion device.

10. The method of claim 9 further comprising:
receiving a selection for said group expansion device and toggling between an expanded view and a collapsed view of said group.

11. The method of claim 1, said focus node comprising a group of items, at least one of said group of items comprising a child item.

12. The method of claim 11 further comprising:
representing said at least one of said group of items with a child item indicator, said child item indicator being at least a portion of an input mechanism configured to expand said child item.

13. The method of claim 1 further comprising:
selecting at least one of said focus node or said second level nodes and performing an operation based on said selecting.

14. A computer readable medium comprising computer executable instructions adapted to:
receive at least a portion of a hierarchy of nodes,
selecting a first node as a focus node, said focus node having a first level within said hierarchical group of nodes;
applying a first visual representation to said focus node;
identifying at least one second level node being associated with a second level, said second level being a child level adjacent to said first level within said hierarchical group of nodes;
applying a second visual representation to said at least one second level node, said second visual representation being a visually inferior representation to said first visual representation;
identifying at least one third level node being associated with a third level, said third level being a parent level adjacent to said first level within said hierarchical group of nodes; and
applying a third visual representation to said at least one third level node, said third visual representation being a visually inferior representation to said first visual representation.

15. The computer readable medium of claim 14, said second visual representation and said third visual representation being the same visual representation.

16. The computer readable medium of claim 14, said second visual representation having a first visually inferior representation attribute and said third visual representation having a second visually inferior representation attribute, said first visually inferior representation attribute being a lesser degree of said second visually inferior representation attribute.

17. The computer readable medium of claim 14, said second visual representation having a first visually inferior representation attribute and said third visual representation having a second visually inferior representation attribute, said first visually inferior representation attribute being a greater degree of said second visually inferior representation attribute.

18. A system comprising:
a representation generator configured to:
determine a focus node and at least one second level node from a hierarchical group of nodes, said focus node having a first level within said hierarchical group of nodes and said second node having a second level within said hierarchical group of nodes, said second level being adjacent to said first level;
determine at least one third level node from said hierarchical group of nodes, said third level being adjacent to said second level and two levels removed from said first level;
determine at least one fourth level node from said hierarchical group of nodes, said fourth level being adjacent to said first level and two levels removed from said second level;
apply a first visual representation to said focus node;
apply a second visual representation to said at least one second level node, said second visual representation being a visually inferior representation to said first visual representation;
apply a third visual representation to said at least one third level node, said third visual representation being a visually inferior representation to said second visual representation;
apply a fourth visual representation to said at least one fourth level node, said fourth visual representation being a visually inferior representation to said first visual representation; and
create a graphical image comprising said focus node and said at least one second level node;
a display configured to display said graphical image; and
an input device configured to point interact with said graphical image.

19. The system of claim 18, said visually inferior comprising:
a smaller scale than a visually superior representation.

20. The system of claim 18, said visually inferior comprising:
a more transparent visual representation than a visually superior representation.
